(19) United States
(12) Patent Application Publication
(10) Pub. No.: US 2005/0043830 A1
(43) Pub. Date: Feb. 24, 2005

(54) Amplitude-scaling resilient audio watermarking method and apparatus based on quantization

(76) Inventors: Kiryung Lee, Seoul (KR); Dong Sik Kim, Seongnam (KR); Kyung Ae Moon, Daejeon (KR); Young Ho Suh, Daejeon (KR)

Correspondence Address: JACOBSON, PRICE, HOLMAN & STERN;PROFESSIONAL LIMITED LIABILITY COMPANY, 400 Seventh Street. N.W., Washington, DC, 20004, US

(21) Appl. No.: 10/700,488

(22) Filed: Nov. 5, 2003

(30) Foreign Application Priority Data
Aug. 20, 2003 (KR) 2003-57682

(51) Int. Cl. G06F 17/00; H04L 9/00

(52) U.S. Cl. 700/94; 713/176

(57) ABSTRACT

Disclosed is an amplitude-scaling resilient audio watermarking apparatus and method. An encoding apparatus includes: a polyphase filterbank for dividing an audio signal into a plurality of subbands; a psychoacoustic module for applying a psychoacoustic model to the audio signal to provide a signal-to-mask ratio; a watermark encoder for evaluating an encoding parameter from the subbands according to the signal-to-mask ratio and embedding the encoding parameter and a watermark into subbands corresponding to the middle frequency; and a synthesis filterbank for synthesizing the subband signals to output a watermarked audio signal. A decoding apparatus includes: a polyphase filterbank for dividing a received audio signal into the predetermined number of subbands; an EM estimator for estimating an scale factor from an encoding parameter contained in the audio signal and a watermarked subband according to an EM algorithm, and generating the quantizer step size Δ_{d} of a decoder according to the amplitude-scaling; a watermark decoder for extracting a watermark from a subband corresponding to the middle frequency considering the quantizer step size; and an integrated determiner for integrating outputs of the watermark decoder to determine a watermark.

### BACKGROUND OF THE INVENTION

1. Field of the Invention

The present invention relates to an audio watermarking apparatus and method, and more particularly, to an amplitude-scaling resilient audio watermarking method based on a quantization.

2. Discussion of the Related Art

Recently, illegal distribution of the digital audio contents over the Internet occurs frequently. Therefore, apparatuses for the copyright protection of digital audio contents are required. Audio watermarking is a method for copyright protection through embedding copyright information in digital audio contents. Embedded watermark should be imperceptible and robust against signal processing procedures and malicious attacks.

LSB modulation, phase shift keying, echo hiding, spread spectrum watermarking, and quantization watermarking have been proposed as audio watermarking methods.

Watermarking method can be categorized as the blind watermarking and the non-blind watermarking with respect to its decoding scheme. The blind watermarking method decodes the embedded watermark without access to the host signal, in which a watermark is not embedded. Early blind watermarking methods are based on the spread spectrum technique, which reduces the host-signal interference by employing a modulation scheme with a long pseudorandom sequence. Also, An advanced quantization watermarking method, which employs the side information at the encoder, has been proposed. In comparison with the conventional spread spectrum watermarking, the advanced quantization watermarking provides better performance by reducing the host-signal interference in the detection process.

However, the quantization watermarking is vulnerable to the amplitude scaling. In other words, if the amplitude of the watermarked signal is scaled by a constant ratio, the decoding performance may be degraded greatly by the mismatch between the amplitude of the decoder's input signal and the quantizer step size of the decoder.

U.S. Pat. No. 6,483,927 discloses a watermarking method based on a quantization, which compensates the attack distortion by estimating the applied attack. In the patent, the embedding region may be determined as the amplitude of the signal, or the transformation coefficients such as the coefficients of DCT, DWT, DFT and the like.

J. J. Eggers, R. Bäuml, R. Tzschoppe and B. Girod, “Scalar Costa Scheme for Information Embedding,” IEEE Transactions on Signal Processing, vol. 51, No. 4, April 2003, pp. 1003-1019, discloses a Scalar Costa Scheme (SCS) for embedding and decoding a watermark using a codebook, which is constructed using uniform scalar quantizers.

The Scalar Costa Scheme (SCS) is a blind watermarking method, which reduces the host-signal interference, and it employs the uniform scalar quantizer for practical implementation. Although watermarking method, which employs the uniform scalar quantizer, is practical with simple implementation, it is very vulnerable to the amplitude scaling, which modifies the amplitude of the watermarked signal.

Accordingly, for the purpose of reliable detection, the quantizer step size of the decoder should be adjusted according to the applied amplitude scaling. The conventional decoder performs the decoding process without adjusting the quantizer step size, thus causing a serious degradation of decoding performance. Additionally, since the amplitude scaling of the audio signal occurs frequently, the decoding of the watermark from the amplitude-scaled signal should be considered importantly. The normalization of audio signals with respect to the root mean square (RMS) value of the amplitude is an example of the amplitude scaling.

Additionally, in order to reliably decode the watermark from the amplitude-scaled signal, Eggers, et. al. proposed an algorithm for estimating the scale factor by using the SCS pilot signal. In the proposed algorithm, a pilot signal is embedded in a manner of the Scalar Costa Scheme (SCS) and the scale factor is estimated through a Fourier analysis of histograms of the pilot.

However, in the conventional method, the pilot signal should be long enough to accurately estimate the scale factor. Since the total length of the host signal is finite, the space for embedding the payload decreases as the length of the pilot signal increases.

### SUMMARY OF THE INVENTION

Accordingly, the present invention is directed to an audio watermarking method and apparatus based on a quantization that substantially obviates one or more problems due to limitations and disadvantages of the related art.

An object of the present invention is to provide an audio watermarking apparatus and method based on a quantization, in which the scale factor of the watermarked signal is estimated just before the actual decoding process by using the expectation maximization (EM) algorithm, and the quantizer step size is adjusted, thereby providing an amplitude-scaling resilient decoding result.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an amplitude-scaling resilient audio watermarking encoding apparatus based on a quantization includes: a polyphase filterbank for dividing an inputted audio signal into a plurality of subbands; a psychoacoustic module for applying a psychoacoustic model to the inputted audio signal to provide a signal-to-mask ratio (SMR); a watermark encoder for evaluating an encoding parameter from the plurality of subbands according to the signal-to-mask ratio (SMR) provided from the psychoacoustic module and embedding the encoding parameter and a watermark into subbands corresponding to the middle frequency among the plurality of subbands; and a synthesis filterbank for synthesizing the divided and watermarked subband signals to output a watermarked audio signal.

An amplitude-scaling resilient audio watermarking decoding apparatus based on a quantization includes: a polyphase filterbank for dividing a received audio signal into the predetermined subbands; an expectation maximization (EM) estimator for estimating the scale factor from an encoding parameter contained in the received audio signal and a watermarked subband according to the EM algorithm, and generating the quantizer step size Δ_{d} of a decoder according to the scale factor; a watermark decoder for extracting a watermark from the selected subband using the estimated quantizer step size; and an integrated determiner for integrating outputs of the watermark decoder to determine a watermark.

A method for encoding an audio signal includes the steps of: dividing an inputted audio signal into subbands; applying a psychoacoustic model to the audio signal to evaluate a signal-to-mask ratio (SMR); evaluating an encoding parameter from the signal-to-mask ratio (SMR); encoding a watermark in each subband according to the evaluated encoding parameter; synthesizing the watermarked subbands; and transmitting watermarked audio signal and the encoding parameter.

A method for decoding an audio signal includes the steps of: receiving the audio signal and a side information; dividing the audio signal into subbands; estimating a scale factor from the side information and the received audio signal by using an expectation maximization (EM) algorithm, and evaluating the quantizer step size of a decoder from the estimated scale factor; decoding a watermark from the subbands using the evaluated quantizer step size; and summing up the decoded values to calculate an average, and calculating a correlation between the average and each codeword of the codebook to determine the embedded watermark.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a concept of the quantization watermarking, which is applied to the present invention;

FIG. 2 is a block diagram of a watermark encoding apparatus according to the present invention;

FIG. 3 is a block diagram of the watermark encoder shown in FIG. 2;

FIG. 4 is a flowchart showing a watermarking encoding method according to the present invention;

FIG. 5 is a block diagram of a watermarking decoding apparatus according to the present invention;

FIG. 6 is a flowchart showing a watermarking decoding method according to the present invention; and

FIG. 7 illustrates simulation results in case that both MP3 lossy compression and amplitude-scaling are applied.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 1 illustrates a concept of the quantization watermarking, which will be applied to the present invention.

Referring to FIG. 1, the quantization watermarking is a method of embedding the watermark by quantizing an audio signal with the quantizer, which is selected according to the corresponding watermark sequence. In other words, the quantization is performed using a quantizer 1 and a quantizer 0, whose quantization reference level is shifted by Δ/2. If a value of a watermark sequence dₙ is “1”, the quantization is performed by the quantizer 1, and if the value is “0”, the quantization is performed by the quantizer 0.

Meanwhile, the quantization watermarking is vulnerable to the amplitude scaling. When the amplitude-scaling is applied to the watermarked signal, the mismatch between the watermarked signal and the quantizer step size of the decoder can degrade the decoding performance. According to the present invention, the quantizer step size is adjusted through an estimation of the applied scale factor. The scale factor is estimated from the input signal of the decoder by the expectation maximization (EM) algorithm.

The present invention employs a blind type detection method and the host signal information at the encoder is exploited in the process of the watermark encoding in order to reduce the host-signal interference. In order for robustness against the lossy compression and the general signal processing, the watermark is repeatedly embedded into the subbands corresponding to the middle frequency. A final result is obtained by integrating each result of the subbands. Since the robustness against attacks varies with respect to the subband, integrating can provide more robustness.

An audio watermarking system of the present invention is generally divided into an encoding apparatus and a decoding apparatus.

1. Encoding Apparatus

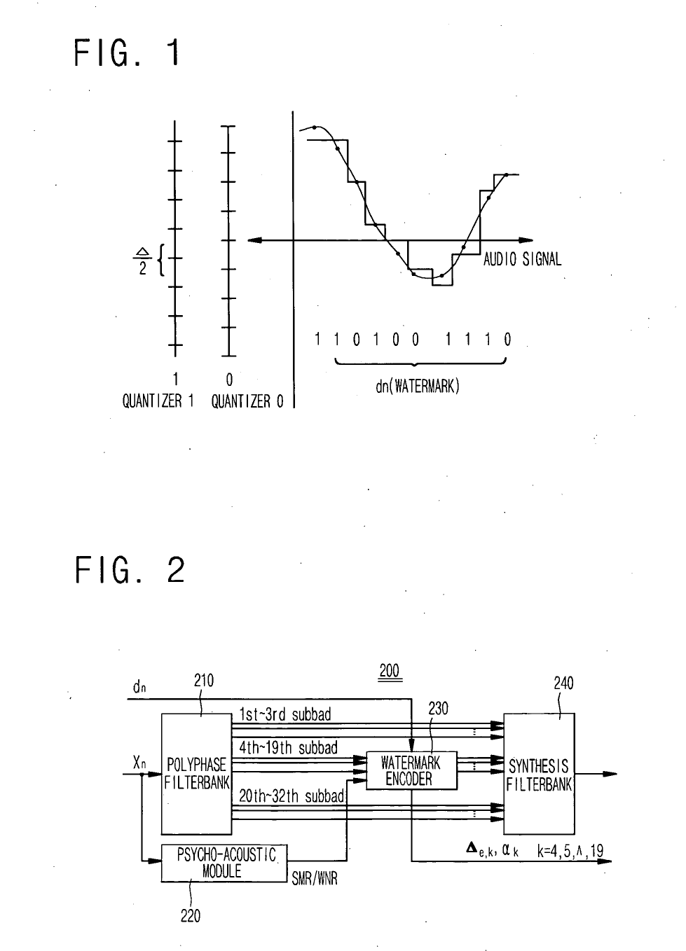

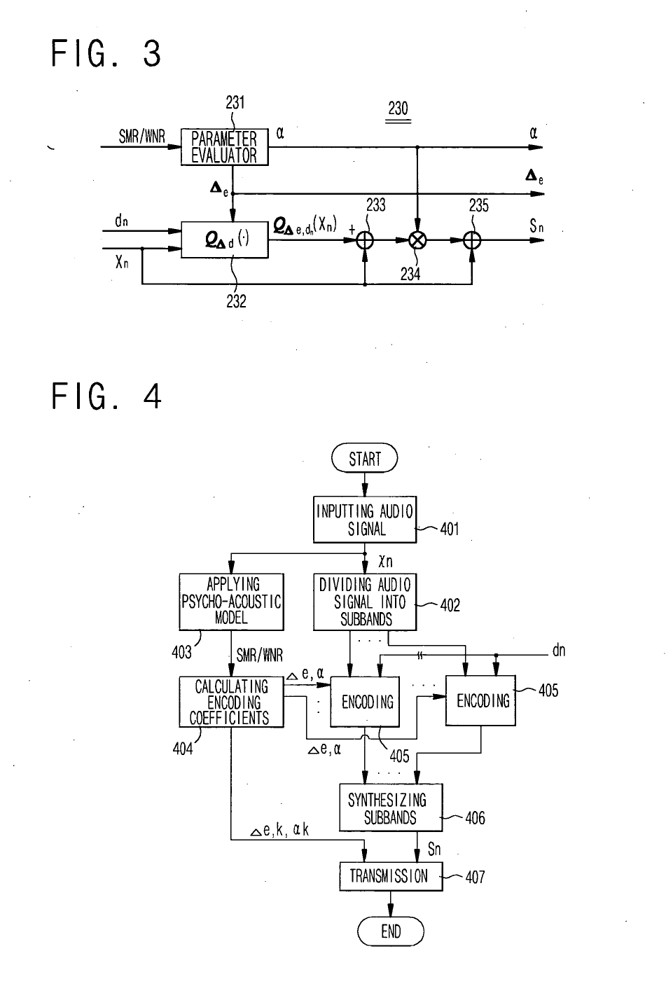

FIG. 2 is a block diagram of a encoding apparatus according to the present invention, FIG. 3 is a embedding algorithm of the watermark encoder of FIG. 2, and FIG. 4 is a flowchart showing a watermarking encoding method according to the present invention.

Referring to FIG. 2, the encoding apparatus 200 of the present invention includes a polyphase filterbank 210 for dividing an inputted audio signal xₙ into 32 subbands according to frequencies, a psychoacoustic module 220 for applying a psychoacoustic model to the inputted audio signal to provide a signal-to-mask ratio (SMR), a watermark encoder 230 for embedding a watermark into middle frequency subbands among the divided subbands according to the signal-to-mask ratio (SMR) of the psychoacoustic module 220 and providing side information, and a synthesis filterbank 240 for synthesizing subband signals to output a watermarked audio signal.

In the encoding apparatus 200, the inputted audio signal xₙ is divided into 32 subbands by the polyphase filterbank 210. In an embodiment of the present invention, considering robustness against the lossy compression, inaudibility and the like, the watermarks are embedded into fourth to nineteenth subbands corresponding to the middle frequency. Since robustness to compression and amplitude scaling is different in each subband according to the corresponding frequencies, the same watermark signal dₙ is repeatedly embedded into the 16 subbands.

For the inaudibility, an intensity of each watermark is determined using the psychoacoustic model. In the 16 watermarked subbands, corresponding encoding parameters Δₑ and α are transmitted to each subband as the side information together with the watermarked audio signal. Here, Δₑ represents the quantizer step size of an encoder and α represents a scale.

Referring to FIG. 3, the watermark encoder 230 for embedding the watermark into the host signal xₙ with respect to each subband includes: a parameter evaluator 231 for evaluating the encoding parameters Δₑ and α from the signal-to-mask ratio (SMR) provided from the psychoacoustic model and an estimation value (WNR) of a noise intensity determined by a specification of a lossy compression; a quantizer 232 for performing an uniform scalar quantization with respect to the audio signal xₙ according to the quantizer step size Δₑ by using a quantizer selected by the watermark dₙ; an adder 233 for subtracting the host signal xₙ from an output of the quantizer 232; a multiplier 234 for multiplying an output of the adder 233 by the scale α; and an adder 235 for adding an output of the multiplier 234 to the host signal xₙ to output a watermarked subband signal sₙ. The watermark embedding algorithm of the present invention is similar to a watermarking method of Scalar Costa Scheme (SCS) proposed by Eggers et. al.

The process of embedding the watermark in the encoding apparatus is implemented through a dithered scalar quantizer. For an input x that is a constant, Q_{Δ,d}(x) is defined by an equation 1.

$${Q}_{Δ , d} ( x ) ≅ Δ ( ⌊ \frac{x}{Δ} - \frac{d}{2} + \frac{1}{2} ⌋ + \frac{d}{2} ) \qquad ( Eq . 1 )$$

where, └c┘ means a maximum integer that is less than or equal to a real number c, a positive constant Δ represents the quantizer step size, and d represents a dither signal having a binary value.

A sequence xₙ of real number represents an host signal (an audio signal). A watermark message is expressed with a binary sequence dₙ through a pseudorandom sequence. When the sequence sₙ of real number represents the watermarked signal, the watermark embedding process is given by an equation 2.
sₙ=(1−α)xₙ+αQ_{Δ}_{ₑ}_{,d}_{ₙ}(xₙ) (Eq. 2)

Here, α(0<α<1) and Δₑ are the encoding parameters used in the embedding process and determined differently according to each subband. The values of the encoding parameters Δₑ and α are determined from the signal-to-mask ratio (SMR) provided from the psychoacoustic model and the estimation value (WNR) of the noise intensity determined by the specification of the lossy compression. These values are transmitted to the decoding apparatus together with the watermarked signal.

A method for encoding the audio signal in the encoding apparatus is shown in FIG. 4. The encoding method includes the steps of: inputting the audio signal (401); dividing the inputted audio signal into subbands (402); applying a psychoacoustic model to the audio signal to evaluate a signal-to-mask ratio (SMR) (403); evaluating an encoding parameter from the signal-to-mask ratio (SMR) (404); encoding a watermark in each subband according to the evaluated encoding parameter (405); synthesizing the watermark encoded subbands (406); and transmitting watermarked audio signal and the encoding parameter.

2. Decoding Apparatus

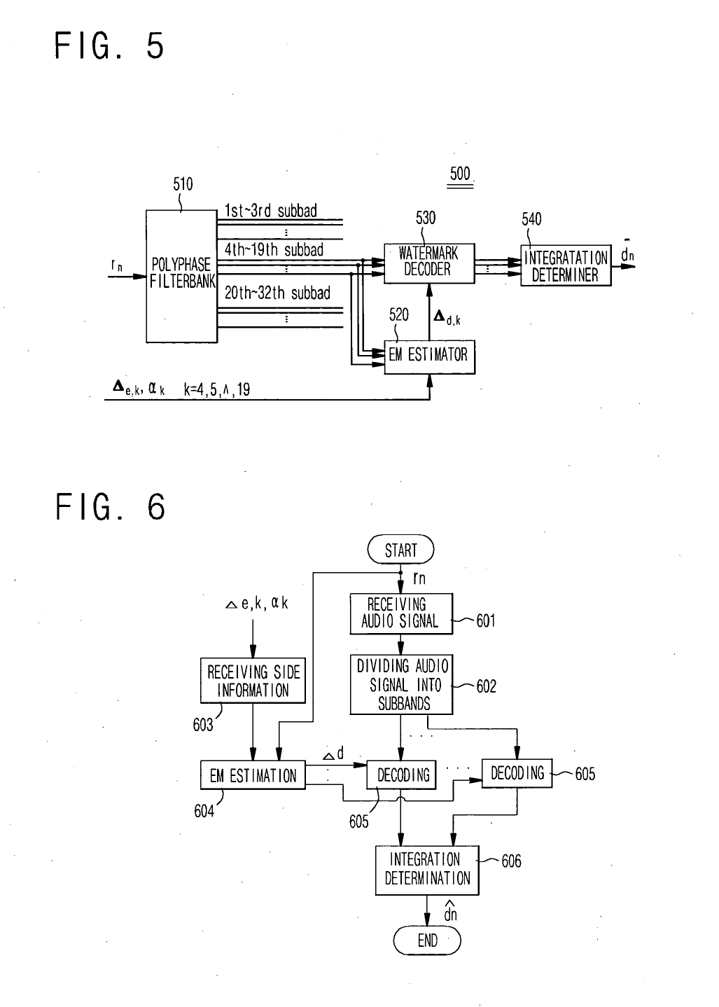

FIG. 5 is a block diagram of a watermark decoding apparatus according to the present invention, and FIG. 6 is a flowchart showing a watermarking decoding method according to the present invention.

Referring to FIG. 5, the decoding apparatus 500 of the present invention includes: a polyphase filterbank 510 for dividing a received audio signal into 32 subbands; an expectation maximization (EM) estimator 520 for estimating an scale factor from a received encoding parameter and a watermarked subband according to the EM algorithm, and generating the quantizer step size Δ_{d} of a decoder according to the amplitude scaling; a watermark decoder 530 for extracting a watermark from the subband corresponding to the middle frequency considering the quantizer step size of the decoder; and an integration determiner 540 for integrating outputs of the watermark decoder 530 to determine the watermark.

A watermark detection in the decoding apparatus 500 is generally carried out through two processes, i.e., a process of estimating the amplitude-scaling and a process of integrating the decoded signals. In the same manner described in the encoding apparatus, a rate g′ is estimated according to the 32 divided subbands and the estimated rate is used to adjust the quantizer step size Δ_{d} to g′Δₑ. The watermark extracted according to the subbands is obtained and a final result is calculated by comparing the average of the results in the 16 subbands with a threshold value.

A process of estimating the scale factor according to the subbands and extracting the watermark will be described below.

The estimation value g′ of the scale factor is evaluated by an estimation method using the EM algorithm. The EM algorithm is used to estimate an average value μₘ of each component probability density function of a gaussian mixture model. The estimated rate g′ is calculated through a linear regression analysis of the estimation value of μₘ, which is obtained by the EM algorithm. A variance σ_{z}² is updated using the rate g′. It is assumed that N number of observed values for estimation with respect to a positive integer N is r₁, r₂,r₃, . . . , r_{N}. A proposed estimation method consists of the repetition of the following steps. First, ηₘ and μₘ are calculated using equations 3 and 4.

$$\begin{matrix}{η}_{m}^{( i )} = \frac{1}{N} {\sum }_{n = 1}^{N} p ( m \vert {r}_{n} , {θ}^{( i - 1 )} ) , for m = 1 , 2 , … , M & ( Eq . 3 ) \\ {μ}_{m}^{( i )} = \frac{{\sum }_{n = 1}^{N} {r}_{n} p ( m \vert {r}_{n} , {θ}^{( i - 1 )} )}{{\sum }_{n = 1}^{N} p ( m \vert {r}_{n} , {θ}^{( r - 1 )} )} , for m = 1 , 2 , … , M & ( Eq . 4 )\end{matrix}$$

Here, the vector θ⁽ⁱ⁻¹⁾ includes a value ηₘ⁽ⁱ⁻¹⁾, a value μₘ⁽ⁱ⁻¹⁾ and a value σ_{z}⁽ⁱ⁻¹⁾ for m=1,2, . . . ,M. Here, p(m|rₙ,θ⁽ⁱ⁻¹⁾) represents a posterior probability with respect to the coefficient θ⁽ⁱ⁻¹⁾. Using the linear regression analysis, an estimation value g⁽ⁱ⁾ of a rate with respect to the i -th repetition is calculated using a minimum value of a mean square error given by an equation 5.

$${\sum }_{m = 1}^{M} {{η}_{m}^{( i )} [ {μ}_{m}^{( i )} - {g}^{( i )} {μ}_{m}^{( i - 1 )} ]}^{2} \qquad ( Eq . 5 )$$

The estimation value g⁽ⁱ⁾ of the rate is given by an equation 6.

$${g}^{( i )} = \frac{{\sum }_{m = 1}^{M} {η}_{m}^{( i )} {μ}_{m}^{( i )} {μ}_{m}^{( i - 1 )}}{{\sum }_{m = 1}^{M} {{η}_{m}^{( i )} [ {μ}_{m}^{( i - 1 )} ]}^{2}} \qquad ( Eq . 6 )$$

The variance σ_{z}⁽ⁱ⁻¹⁾ is updated by an equation 7.

$${σ}_{z}^{( i )} = \sqrt{\frac{{[ {g}^{( i )} ]}^{2} {( {D}_{2} - {D}_{1} )}^{2}}{{D}_{1}} + ( {D}_{2} - {D}_{1} )} \qquad ( Eq . 7 )$$

In the proposed method, initial values of the coefficients are set like an equation 8.

$${σ}_{z}^{( 0 )} = \sqrt{\frac{{( {D}_{2} - {D}_{1} )}^{2}}{{D}_{1}} + ( {D}_{2} - {D}_{1} )} \\ {μ}_{m}^{( 0 )} = \frac{{Δ}_{e}}{2} ( m - [ \frac{M - 1}{2} ] ) , for m = 1 , 2 , … , M \\ {η}_{m}^{( 0 )} = \frac{1}{M} , for m = 1 , 2 , … , M \qquad ( Eq . 8 )$$

The steps of updating these coefficients are repeated L times. A final rate is given by an equation 9.
ĝ=g^{L} (Eq. 9)

The decoding process from the estimated rate g′ is achieved using the adjusted quantizer step size Δ_{d}=g′Δₑ.

A detecting process from the input signal rₙ in each subband will be described below. First, the input signal rₙ is quantized through the quantizer having the quantizer step size Δ_{d} and the dither d(=0) to thereby provide a result Q_{Δ}_{_{d}}_{,0}(rₙ). Using g′ that is a estimation result of g, the quantizer step size Δ_{d} of the decoder is made to have a value g′Δₑ.

Assuming that \tilde{r}ₙ represents a quantization error, \tilde{r}ₙ is given by an equation 10.
\tilde{r}ₙ≅rₙ−Q_{Δ}_{_{d}}_{,0}(rₙ) (Eq. 10)

The estimated watermark signal \hat{d}ₙ is calculated by an equation 11.

$${\hat{d}}_{n} = \frac{4 \vert {\tilde{r}}_{n} \vert}{{Δ}_{d}} - 1 \qquad ( Eq . 11 )$$

An average of the results obtained in the 16 subbands is calculated, and a correlation between a resulting code and codes of a codebook is calculated. As a result, an index of code having the largest correlation is an embedded watermark information.

Referring to FIG. 6, the decoding method in the decoding apparatus includes the steps of: receiving an audio signal (601); dividing the audio signal into subbands (602); receiving a side information (603); estimating an scale factor from the side information and the audio signal by using an expectation maximization (EM) algorithm, and evaluating the quantizer step size from the estimated amplitude-scale rate (604); decoding a watermark from the subbands considering the evaluated quantizer step size (605); and summing up the decoded values to calculate an average, and calculating a correlation between the average and codes of a codebook to thereby obtain a watermark (606).

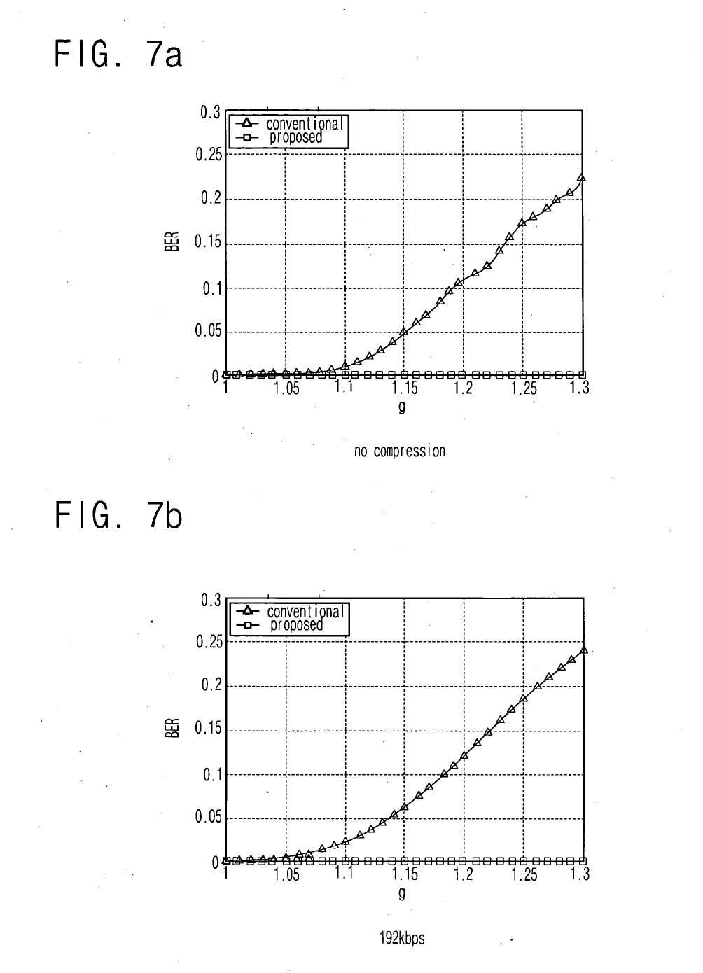

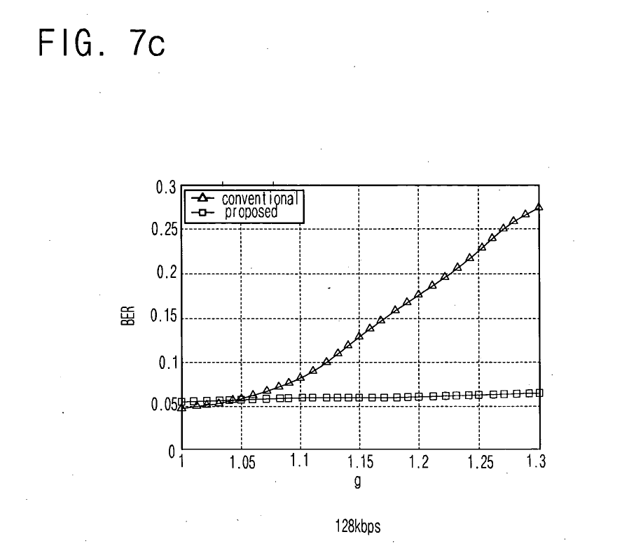

FIG. 7 illustrates simulation results when MP3 lossy compression and the amplitude scaling are applied, in which (A) is a case of no compression, (B) is a case of 192 kbps, and (C) is a case of 128 kbps.

In the graphs, the abscissa denotes a scale factor g and the ordinate denotes the bit error rate. A triangular solid line and a circular solid line represent a characteristic according to the prior art and the present invention, respectively. As shown in the graphs, although the bit error rate according to the prior art increases rapidly when the scale factor g increases, the bit error rate according to the present invention is not influenced by the amplitude scaling regardless of the scale factor.

As described above, according to the present invention, the scale factor is estimated from the watermarked signal itself without using additional signals such as a pilot signal. Therefore, even when an amplitude of the watermarked signal inputted into the decoder is changed, the watermark can be extracted without reducing an information embedding capacity. Additionally, the watermark signal is repeatedly embedded into areas of a low frequency subband, which is robust to a lossy compression or a low pass filtering, to areas of middle frequency subbands, which is robust to the amplitude scaling. Then, each result is summed up to extract the final watermark. Therefore, the present invention provides robustness in both the lossy compression and the amplitude scaling.

The lossy compression such as MP3 or the amplitude scaling of the audio signal may be used frequently in actual digital audio signal and considered as unintended attacks. In such case, the method and apparatus of the present invention is robust or resilient with respect to unintended changes, even when the watermarking is used for the purpose of embedding side information as well as protection of copyrights or a verification of integrity.

It will be apparent to those skilled in the art that various modifications and variations can be made in the present invention. Thus, it is intended that the present invention covers the modifications and variations of this invention provided they come within the scope of the appended claims and their equivalents.

1. An amplitude-scaling resilient audio watermarking encoding apparatus based on a quantization, comprising:
a polyphase filterbank for dividing an inputted audio signal into a plurality of subbands;
a psychoacoustic module for applying a psychoacoustic model to the inputted audio signal to provide a signal-to-mask ratio (SMR);
a watermark encoder for evaluating an encoding parameter from the plurality of subbands according to the signal-to-mask ratio (SMR) provided from the psychoacoustic module and embedding the encoding parameter and a watermark into subbands having middle frequency subbands among the plurality of subbands; and
a synthesis filterbank for synthesizing the divided and watermarked subband signals to output a watermarked audio signal.

2. The amplitude-scaling resilient audio watermarking encoding apparatus of claim 1, wherein the watermark encoder includes:
a parameter evaluator for evaluating the encoding parameter value (Δₑ,α) from the signal-to-mask ratio provided from the psychoacoustic model and an estimation value (WNR) of a noise intensity determined by a specification of a lossy compression;
a quantizer for performing an uniform scalar quantization with respect to an audio signal xₙ according to the quantizer step size Δₑ of an encoder by using a quantizer selected by a watermark dₙ;
an adder for subtracting the host signal xₙ from an output of the quantizer;
a multiplier for multiplying an output of the adder by the scale α; and
an adder for adding an output of the multiplier to the host signal xₙ to output a watermarked subband signal sₙ.

3. An amplitude-scaling resilient audio watermarking decoding apparatus based on a quantization, comprising:
a polyphase filterbank for dividing a received audio signal into the predetermined number of subbands;
an expectation maximization (EM) estimator for estimating an scale factor from an encoding parameter contained in the received audio signal and a watermarked subband according to an EM algorithm, and generating the quantizer step size Δ_{d} of a decoder according to the amplitude-scaling;
a watermark decoder for extracting a watermark from a subband corresponding to the middle frequency considering the quantizer step size; and
an integrated determiner for integrating outputs of the watermark decoder to determine a watermark.

4. A method for encoding an audio signal, comprising the steps of:
dividing an inputted audio signal into subbands;
applying a psychoacoustic model to the audio signal to evaluate a signal-to-mask ratio (SMR);
evaluating an encoding parameter from the signal-to-mask ratio (SMR);
encoding a watermark in each subband according to the evaluated encoding parameter;
synthesizing the watermarked subbands; and
transmitting watermarked audio signal and the encoding parameter.

5. The method of claim 4, wherein the step of encoding the watermark is performed by embedding the watermark in middle frequency subbands.

6. A method for decoding an audio signal, the audio signal being encoded by the method of claim 4, the method comprising the steps of:
receiving the audio signal and a side information;
dividing the audio signal into subbands;
estimating an scale factor from the side information and the received audio signal by using an expectation maximization (EM) algorithm, and evaluating the quantizer step size of a decoder from the estimated amplitude-scale rate;
decoding a watermark from the subbands considering the evaluated quantizer step size; and
summing up the decoded values to calculate an average, and calculating a correlation between the average and codes of a codebook to obtain a watermark.

7. The method of claim 6, wherein the quantizer step size Δ_{d} is calculated by multiplying the received quantizer step size of the encoder by the estimated scale factor.
